(19) United States
(12) Patent Application Publication
(10) Pub. No.: US 2016/0122186 A1
(43) Pub. Date: May 5, 2016

(54) MESOPOROUS CARBON MATERIAL AND RELATED METHODS

(71) Applicant: Fraunhofer USA, Inc., Plymouth, MI (US)

(72) Inventors: Tahereh Jafari, Columbia, CT (US); Ting Jiang, Storrs, CT (US); Wei Zhong, Williamantic, CT (US); Steven L. Suib, Storrs, CT (US); Prabhakar Singh, Storrs, CT (US)

(73) Assignee: Fraunhofer USA, Inc., Plymouth, MI (US)

(21) Appl. No.: 14/815,913

(22) Filed: Jul. 31, 2015

Related U.S. Application Data
(60) Provisional application No. 62/031,843, filed on Jul. 31, 2014.

(51) Int. Cl. C01B 31/02; B01D 53/04; B01J 20/30; B01J 20/20; B01J 20/28

(52) U.S. Cl. CPC C01B 31/02; B01J 20/20; B01J 20/28083; B01J 20/2808; B01J 20/28059; B01J 20/28061; B01J 20/28064; B01J 20/28088; B01J 20/3057; B01J 20/3078; B01D 53/04; B01D 2253/102; B01D 2257/304; B01D 2257/306; B01D 2257/556

(57) ABSTRACT

Mesoporous carbon material and methods of forming and using the same are provided.

### BACKGROUND

1. Technical Field

The present disclosure relates to mesoporous carbon material and methods of forming and using the same (e.g., to adsorb gases such as siloxane).

2. Discussion of the Related Art

Siloxanes, the biogas pollutant that cause mechanical corrosion by its oxidation and conversion to organic compounds, have been investigated to be removed from landfill gas through different techniques. Table 1 indicates one type of hard to removed cyclic siloxane.

TABLE 1

| | | | Molecular | Vapor |
|---|---|---|---|---|
| Siloxane type | Formula | Abbreviation | weight | Pressure |
| Octamethycyclo- | C₈H₂₄O₄Si₄ | D4 | 296.6 | 0.13 |
| tetrasiloxane | | | | |

There are various methods to remove siloxane gas including biological methods, cooling, absorption, catalysts and adsorption. Among these techniques, in some cases, adsorption using an active solid material (e.g., silica gel, alumina, activated carbon) can be the simplest approach. The pollutant is adsorbed by physical interaction with the surface of the active solid material.

There is a need to develop improved materials that can adsorb gaseous pollutants such as siloxane.

### SUMMARY

Mesoporous carbon material and methods of forming and using the same are provided.

In one aspect, a mesoporous carbon material is provided. The mesoporous carbon material has an average pore size of between 0.3 nm and 50 nm, a pore size distribution of less than 5 nm and a surface area between 50 m²/g and 1000 m²/g.

In one aspect, a method is provided. The method comprises adsorbing gas with a mesoporous carbon material, wherein the mesoporous carbon material has an average pore size of between 0.3 nm and 50 nm, a pore size distribution of less than 5 nm and a surface area of between 50 m²/g and 1000 m²/g.

In one aspect, a method of forming a mesoporous carbon material is provided. The method comprises forming a mesoporous silica template. The method further comprises forming a carbon precursor on surfaces of the silica template and removing the silica template to yield mesoporous carbon material.

Other aspects, embodiments and features should be understood from the following description.

### BRIEF DESCRIPTION OF THE DRAWINGS

FIG. 1A shows Low angle PXRD of the mesoporous carbon material, according to some embodiments.

FIG. 1B shows Wide angle PXRD of the mesoporous carbon material, according to some embodiments.

FIG. 1C shows N₂ sorption isotherms of the mesoporous carbon material, according to some embodiments.

FIG. 1D shows BJH pore size distributions of the mesoporous carbon material, according to some embodiments.

FIGS. 2A-2C show FESEM images of the mesoporous carbon material, according to some embodiments.

FIG. 3A shows a Breakthrough diagram of the mesoporous carbon adsorbents and blank test according to some embodiments.

FIG. 3B shows Adsorbed siloxane by the mesoporous carbon versus reaction time, according to some embodiments.

### DETAILED DESCRIPTION

Mesoporous carbon material and methods of forming and using the same are provided. The mesoporous carbon material may be characterized as having extremely high surface areas and very narrow pore size distributions (e.g., monomodal pore size distributions). These characteristics enable the mesoporous carbon material to be particularly well suited for use in applications that involve adsorbing gases. For example, the materials may be used to adsorb gaseous pollutants, such as siloxane. The materials may be produced in a process that involves forming a silica template, for example in an inverse micelle sol-gel process, on which a carbon precursor is deposited. The silica substrate may be removed to yield the mesoporous carbon structure.

The mesoporous carbon material may have an average pore size of between 0.3 nm and 50 nm. In some embodiments, the average pore size may be between 0.3 nm and 12 nm.

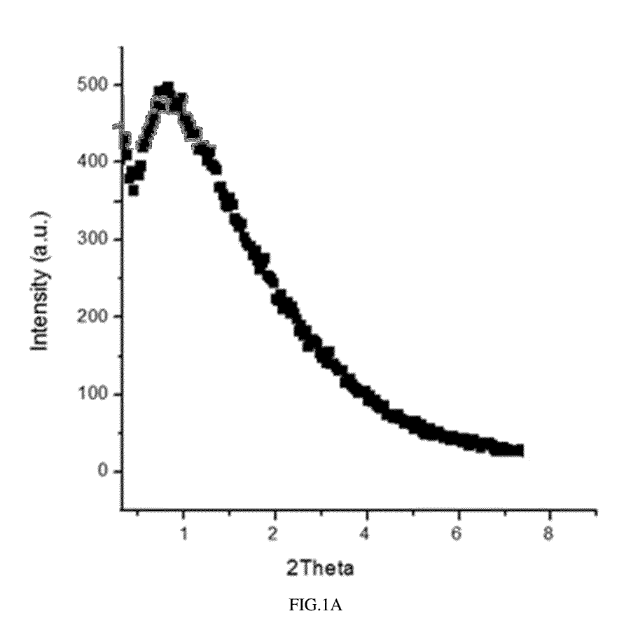

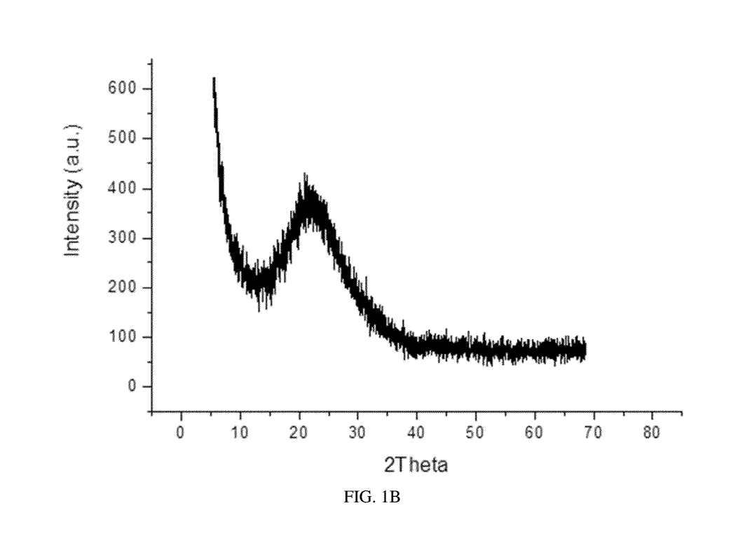

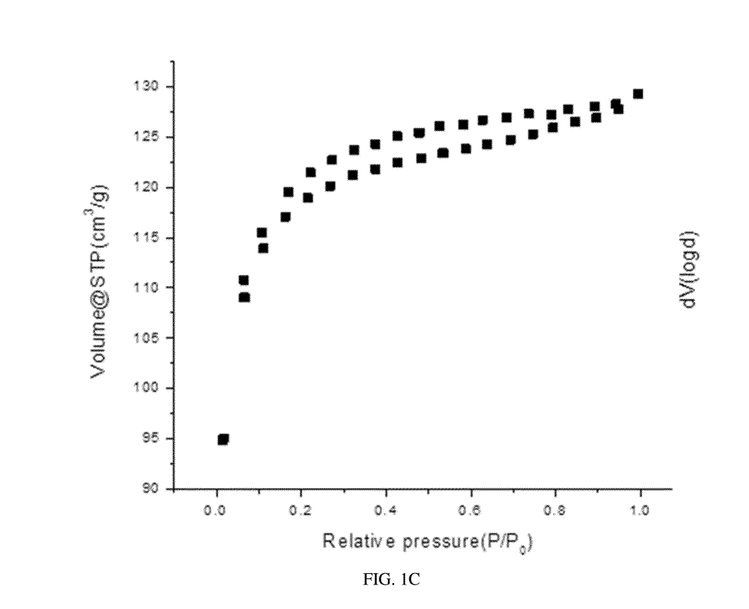

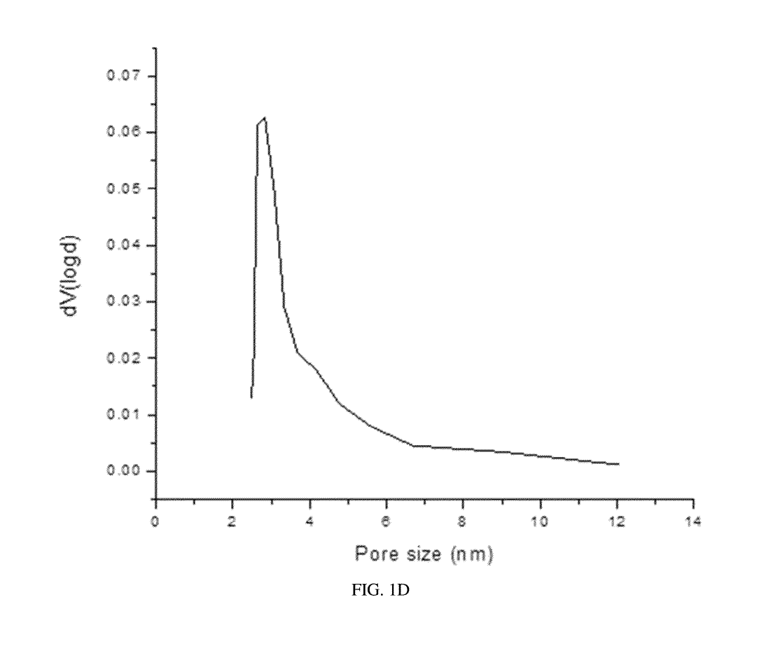

As noted above, the mesoporous carbon material may have a very narrow pore size distribution. For example, the pore size distribution may be less than 5 nm. FIG. 1D shows a mesoporous carbon material including a representative pore size distribution meeting this criteria. In some embodiments, the pore size distribution is less than 3 nm. In some embodiments, the pore size distribution is between 1 nm and 2 nm. The pore size distribution may be monomodal.

The mesoporous carbon material can have high surface areas. For example, the surface area may be between 50 and 1000 m²/g. For example, the surface area may be between 400 and 1000 m²/g. The surface area may be measured using BET surface area measurement techniques.

The mesoporous carbon material may have crystalline walls.

Methods of forming the mesoporous carbon material described herein may include a sol-gel process. In some cases, the methods may include an inverse micelle process. A general inverse micelle process is described, for example, in “A General Approach to Crystalline and Monomodal Pore Size Mesoporous Materials” by Poyraz, A.; Kuo, C. H., Biswas, S.; King'ondu, C. K.; Suib, S. L., Nature Comm., 2013, 4, 3952, 1-10, which is incorporated herein by reference in its entirety. In some embodiments, the method involves forming a mesoporous silica template using an inverse micelle process. The sol-gel based inverse micelle method may use an acid (e.g., HNO₃) at a low pH and a silicon source. For example, silicon oxo-clusters which are confined in hydrated inverse micelles may interact with a surfactant by hydrogen bonding. The inverse micelles formed by surfactant species serve as nanoreactors and individual surfactant molecules in the inverse micelles form a physical barrier between the oxo-clusters preventing uncontrolled aggregation. An interface modifier may be used such as 1-butanol polyethylene oxide (for both (PEO) and poly-propylene oxide (PPO)) which compensates for the decrease of the aggregation number, hinders the condensation by forming a physical barrier between the oxo-clusters and limits oxidation of surfactant molecules present in the micelle. Silicon precursor loaded inverse micelles are packed on solvent removal; packing is followed by oxidation and condensation of the silicon precursors in the micelles. This forms silica which can then be directly used as silica template for mesoporous carbon synthesis.

A carbon precursor may be formed on surfaces of the silica template during the inverse micelle process. For example, the carbon precursor may be a surfactant used in the inverse micelle process. Any suitable surfactant capable of providing a suitable carbon precursor may be used. Such surfactants comprise carbon (e.g., hydrocarbons). Examples of suitable surfactants include, but are not limited to, poloxamers (e.g., Pluronic P123) surfactant and polyoxyethylene glycol alkyl ethers (e.g., Brij56), amongst others. The methods may involve removing the silica template (e.g., by etching in a base) to yield mesoporous carbon material. The carbon precursor, for example, may be carbonized to produce the mesoporous carbon material. For example, the carbon precursor may be carbonized in a heating step.

As noted above, the mesoporous carbon material may be used to adsorb gas. In some embodiments, the gas is a biogas, e.g., from landfills. For example, the gas may be a siloxane. Removal of siloxanes may be advantageous in a number of applications. For example, when a biogas is used as a fuel for electricity generation, trace amounts of siloxanes may damage the combustion engines. Also, the process of treating wastewater results in the production of digester gas, which is a methane-rich gas that can be used to produce electricity and heat. In order to generate energy by the methane-rich digester gas, the digester gas should be purified from siloxanes before going toward the engine. In some embodiments, the mesoporous materials play an important role to remove siloxanes from both landfill gas and digest gas stream and deliver siloxane free gas to reduce maintenance cost. It should be understood that the mesoporous carbon materials can be used to move other gases and the methods described herein and are not limited in this regard. For example, the mesoporous carbon materials may be used to remove hydrogen sulfide (H₂S) or carbonyl sulfide. In some embodiments, the mesoporous carbon materials may be used to remove multiple gases (e.g., hydrogen sulfide and siloxane) in simultaneously in the same method.

In applications in which the mesoporous carbon adsorbs gas, the material may be confined in a column into which the is introduced according to know n techniques.

The following examples illustrate certain embodiments of the invention, though are not intended to be limiting.

### Example

### Synthesis Method

Tetraethylorthosilicate (0.02 mol) was diluted in a solution containing 0.188 mol (14 g) of 1-butanol, 0.032 mol (2 g) of HNO3 and 3.4×10−4 mol (2 g) of P123 surfactant in a 150-ml beaker at RT and under magnetic stirring. The obtained clear gel was placed in an oven at 120° C. for 4-6 h. The obtained transparent yellow film was placed in a calcination cuvette and calcined directly under air at 450° C. for 4 h (1° C. min−1 heating rate). As-synthesized mesoporous silica sample (Meso-Si) was placed in a tubular furnace and heated to 900° C. for 2 h under an Ar atmosphere. Resulting black material may be put and stirred in a 0.5 M warm NaOH solution for etching out the silica to form mesoporous carbon. The formed black powder may be washed one or more times with water and ethanol, and dried in a vacuum oven overnight. A mesoporous carbon material was produced.

Physicochemical Properties

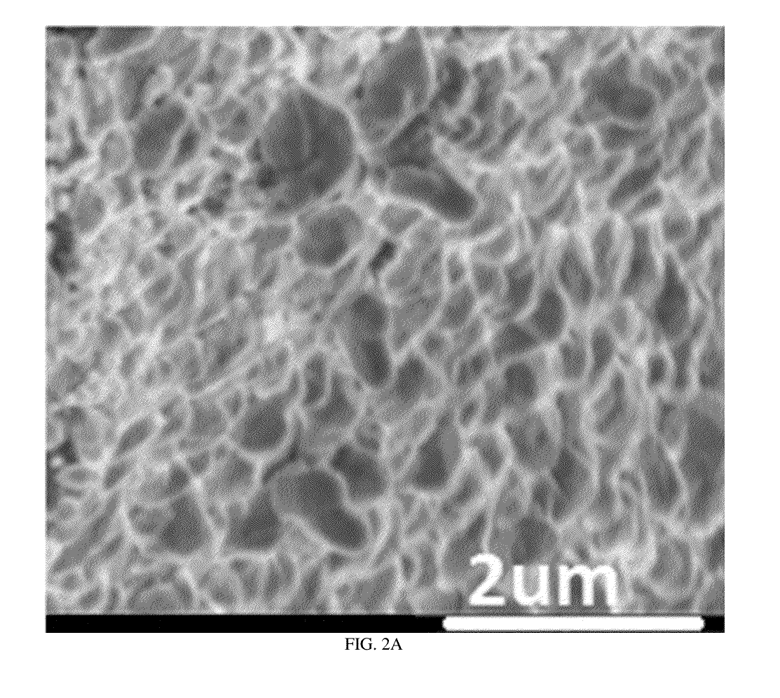

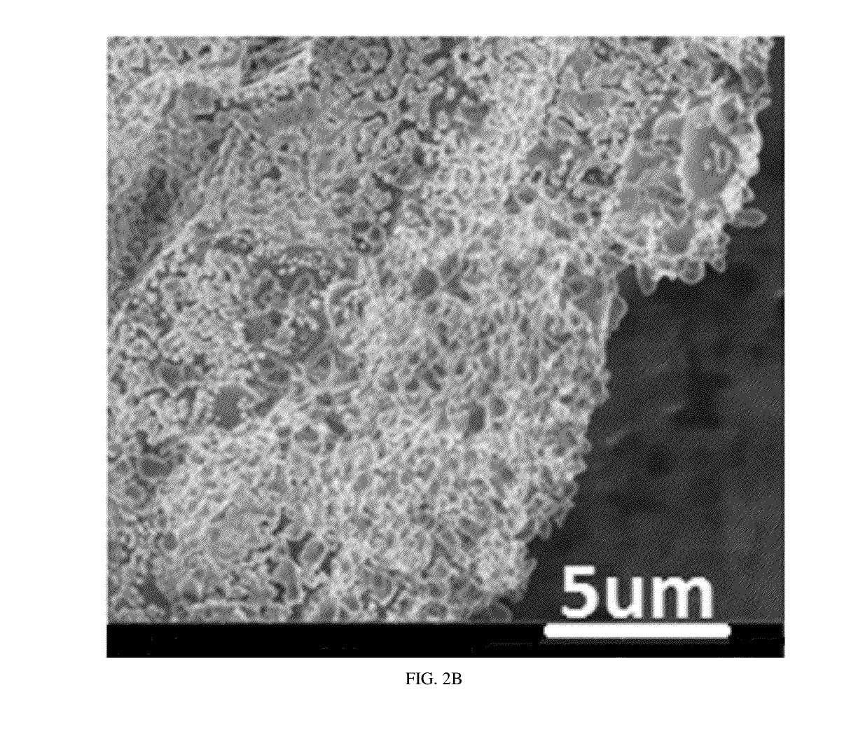

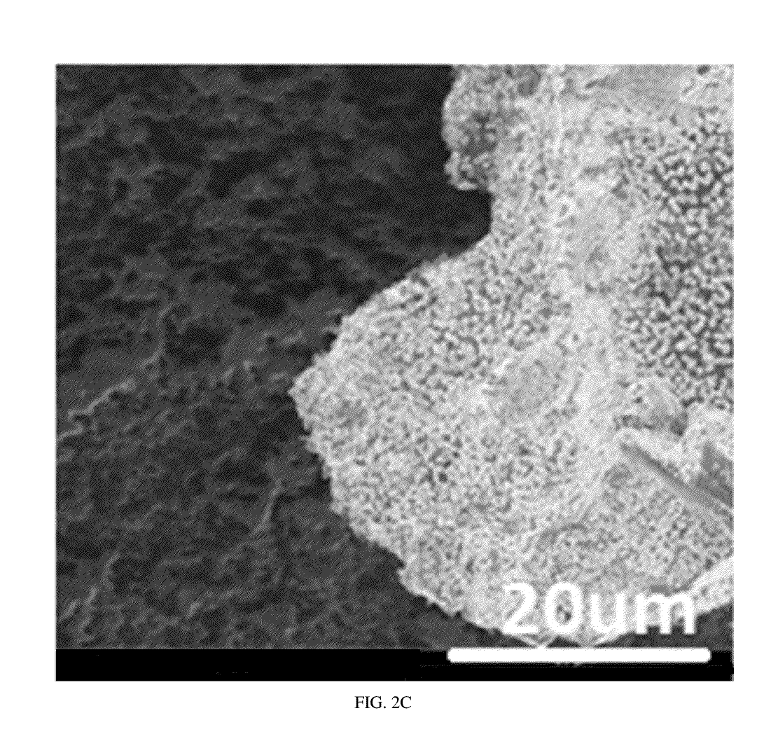

The physicochemical characterization results of the mesoporous carbon material are illustrated in FIGS. 1A-1D. The low angle diffraction pattern (FIG. 1A) indicates the presence of ordered mesoporosity, which is also the size of the aggregated nanoparticles. No sharp peaks in the high angle PXRD (FIG. 1B) showed the amorphous nature of the materials. The N₂ sorption isotherms (FIG. 1C) can be labeled as a characteristic type-IV isotherm, which contains mesoporosity and has a high energy of adsorption. The pore size distribution (FIG. 1D) along with pore diameter of 3.5 nm confirms the mesoporisity and monomodal structure of the materials. The FESEM images (FIGS. 2A-2C) displayed the morphological aspect of the materials.

Test Result of Adsorption Reaction

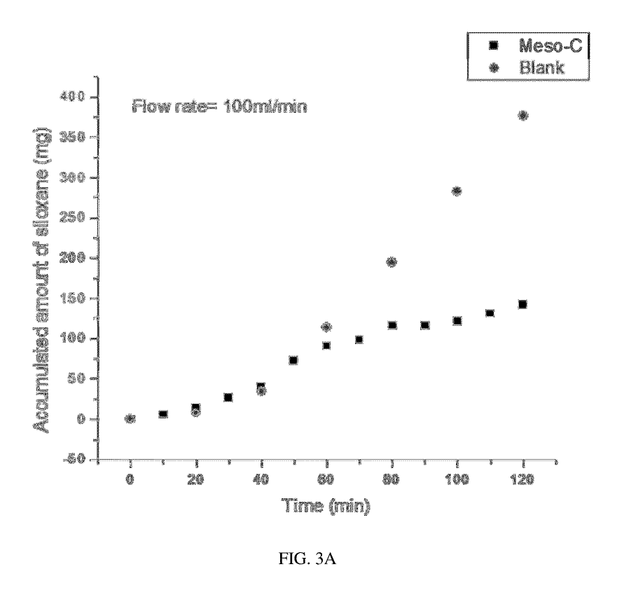

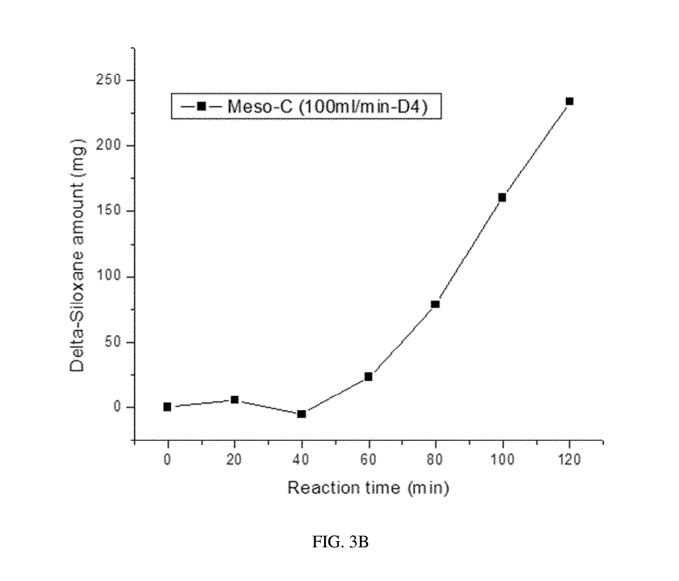

Adsorbents' performance of D4 adsorption tests were run at flow rate of 100 ml/min under 25° C. isotherm oil baths. The siloxane amount in the carrier gas is 525 mg/60 mins. FIG. 3A shows the breakthrough diagram of mesoporous carbon adsorbents and blank test, according to some embodiments, by plotting accumulated siloxane amount versus time. FIG. 3B shows the residue siloxane amount in the solvent versus time. From FIG. 3B, it shows that the mesoporous carbon, according to some embodiments, was still adsorbing siloxane even after 120 mins. If the adsorbents were saturated, the amount of residue siloxane in the solvent should be stable and became almost the same.

What is claimed is:

1. A mesoporous carbon material having:
an average pore size of between 0.3 nm and 50 nm;
a pore size distribution of less than 5 nm; and
a surface area of between 50 m²/g and 1000 m²/g.

2. The mesoporous carbon material of claim 1, wherein the surface area is between 400 m²/g and 1000 m²/g.

3. The mesoporous carbon material of claim 1, wherein the pore size distribution is less than 3 nm.

4. The mesoporous carbon material of claim 1, wherein the pore size distribution is between 1 nm and 2 nm.

5. The mesoporous carbon material of claim 1, wherein the average pore size is between 0.3 nm and 12 nm.

6. The mesoporous carbon material of claim 1, wherein the material includes crystalline walls.

7. A method of adsorping gas;
adsorbing gas with a mesoporous carbon material, wherein the mesoporous carbon material has an average pore size of between 0.3 nm and 50 nm, a pore size distribution of less than 5 nm and a surface area of between 50 m²/g and 1000 m²/g.

8. The method of claim 6, wherein the gas is a biogas.

9. The method of claim 6, wherein the gas is a siloxane.

10. The method of claim 6, wherein the gas is hydrogen sulfide or carbonyl sulfide.

11. The method of claim 7, wherein the mesoporous carbon material is confined in a column into which the gas introduced.

12. A method of forming a mesoporous carbon material comprising:
forming a mesoporous silica template;
forming a carbon precursor on surfaces of the silica template;
removing the silica template to yield mesoporous carbon material.

13. The method of claim 12, wherein the silica template is formed using a sol-gel method.

14. The method of claim 13, wherein the sol-gel method comprises formation of micelles.

15. The method of claim 14, wherein the micelles are . . . .

16. The method of claim 12, wherein the carbon precursor is carbonized.

17. The method of claim 16, wherein the carbon precursor is carbonized in a heating step.

18. The method of claim 12, wherein the carbon precursor is a surfactant.

19. The method of claim 12, wherein the mesoporous carbon material has an average pore size of between 0.3 nm and 50 nm and a surface area of between 50 m²/g and 1000 m²/g.

20. The method of claim 19, wherein the mesoporous carbon material has a pore size distribution of less than 5 nm.
